(19) United States
(12) Patent Application Publication
(10) Pub. No.: US 2005/0265721 A1
(43) Pub. Date: Dec. 1, 2005

(54) Multi-band architecture for DWDM rings

(75) Inventor: Michel Pigeon, Ottawa (CA)

Correspondence Address: MARKS & CLERK, P.O. BOX 957, STATION B, OTTAWA, ON, K1P 5S7, CA

(73) Assignee: Meriton Networks Inc., Ottawa (CA)

(21) Appl. No.: 11/128,393

(22) Filed: May 13, 2005

Related U.S. Application Data
(60) Provisional application No. 60/570,450, filed on May 13, 2004.

(51) Int. Cl. H04J 14/02

(52) U.S. Cl. 398/85

(57) ABSTRACT

An optical architecture to simplify optical link engineering and network upgrades for WDM OADM rings is described. Each access site that is joined to an optical transmission medium is provided with a multi-band filter structure that is designed to add/drop all bands in the hubbed ring. In this way bands can be added to the ring without necessitating the re-engineering of the system. The approach is cost effective and more power efficient than the prior art single band filter structures.

### FIELD OF THE INVENTION

This invention relates to telecommunication systems and more particularly to the design of Wavelength Division Multiplexed (WDM) optical transport equipment for telecommunication systems.

### BACKGROUND

Wavelength Division Multiplexed (WDM) optical rings are used in carrier networks to transparently transport a whole range of optical protocols. The wavelengths used to carry the optical traffic are usually grouped in bands of 3 or 4 wavelengths. This partioning in bands minimizes the amount of equipment needed at each OADM (Optical Add Drop Multiplex) site by adding and dropping only the bands that are required at that site and optically passing through the wavelengths from other bands. This approach works particularly well in a hubbed ring configuration where the traffic is collected at access points around the ring and transported to a hub or central location. A different band would then be deployed at every access site and all the bands used around the ring would terminate at the hub site as shown in FIG. 1. The example shown in FIG. 1 is representative of traditional approaches using single band filters for deployment of WDM optical rings. This approach is described in U.S. Pat. No. 6,529,300, “WDM optical network with passive pass-through at each node” by Milton, Valis, Totti, Liu and Pigeon, and the contents thereof are incorporated herein by reference. In the Milton et al patent a communications network has a plurality of nodes interconnected by an optical transmission medium such as an optical fibre. The transmission medium is capable of carrying a plurality of wavelengths organized into bands. A filter at each node is specifically designed to drop a band associated with the node and passively forwards all other bands through the transmission medium. A device is also provided at each node for the purpose of adding a band to the transmission medium. Communication can be established directly between a pair of nodes in the network sharing a common band without the active intervention of any intervening node(s).

One of the main issues with this approach is that the addition of one new band around the ring would cause interruption of the traffic around the ring and might change the optical link engineering to the point where optical amplifiers would need to be added around the ring. When optical amplifiers are used in OADM rings, power balancing of the wavelengths to the lowest power channel must be performed every time a new wavelength is added or removed to ensure proper operation of the optical amplifiers. Moreover, in typical networks, the traffic patterns are meshed in nature and are subject to change over time. It then becomes difficult to plan the initial ring configuration and even more difficult to change the network to accommodate the changes in traffic patterns. The complexity of the current generation of OADMs and the operational costs associated with them has prevented their widespread deployment in carrier's network.

Accordingly, there is a need for a more effective architecture for the deployment and maintenance of OADM rings.

### SUMMARY OF THE INVENTION

The purpose of the invention is to address the issues summarized above and simplify the deployment and maintenance of OADM rings. According to the present invention the solution consists of deploying a multi-band filter architecture wherein filters for all the bands are provided at every site. This optical network architecture allows the addition of bands and channels at a site over time without interrupting the traffic around the ring. The carrier can decide, as demands of the network evolve, if the traffic from a given band will be added/dropped or optically passed through at each given site.

Since all the band filters are present at all the sites, the optical link engineering does not change as new bands are used at a given site. The optical link budget remains unchanged whether only one band or all eight bands are used around the ring or at a given site. The number and location of optical amplifiers also remain unchanged.

### BRIEF DESCRIPTION OF THE DRAWINGS

The invention will now be described in greater detail with reference to the attached drawings wherein:

FIG. 1a illustrates the single band architecture for a hubbed ring according to the prior art,

FIG. 1b illustrates the topology of the single band filter of FIG. 1a;

FIG. 2a illustrates the multi-band architecture according to the present invention; and

FIG. 2b shows the topology of the multi-band filter of FIG. 2a.

### DETAILED DESCRIPTION OF THE INVENTION

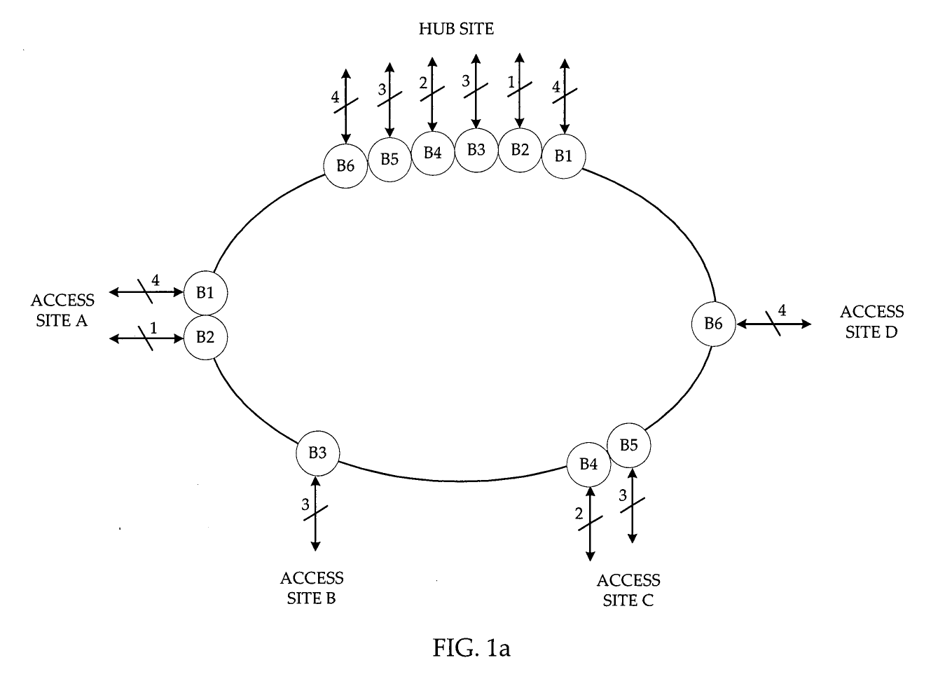

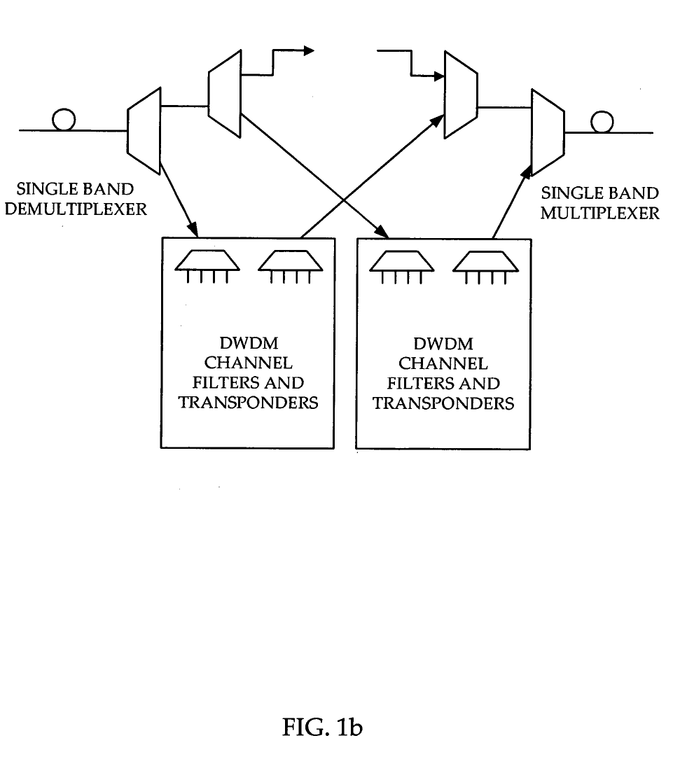

The single band architecture depicted in FIG. 1a illustrates a Hub Site and access sites A, B, C and D. Bands B1 through B6 are collected at the Hub site for use in communicating with selected access sites over the transmission medium joining the sites. A single band filter is deployed at Access sites B and D for adding/dropping bands B3 and B6 respectively. Access sites A and C have filters for adding/dropping bands B1, B2 and B4, B5 respectively.

As shown in the topology depiction of FIG. 1b single band filters are joined in cascade to multiplex/demultiplex more than one band.

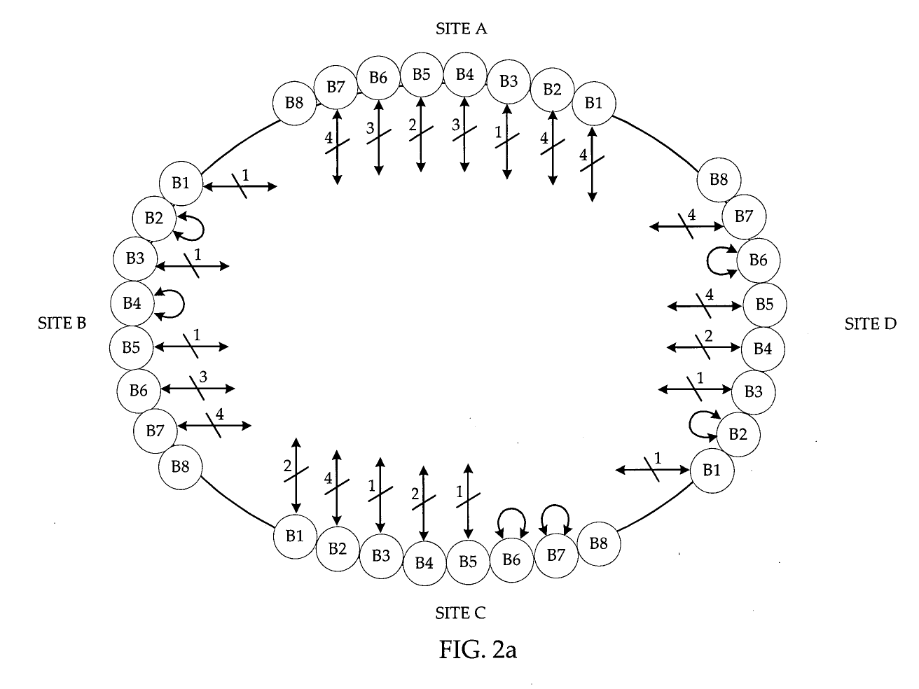

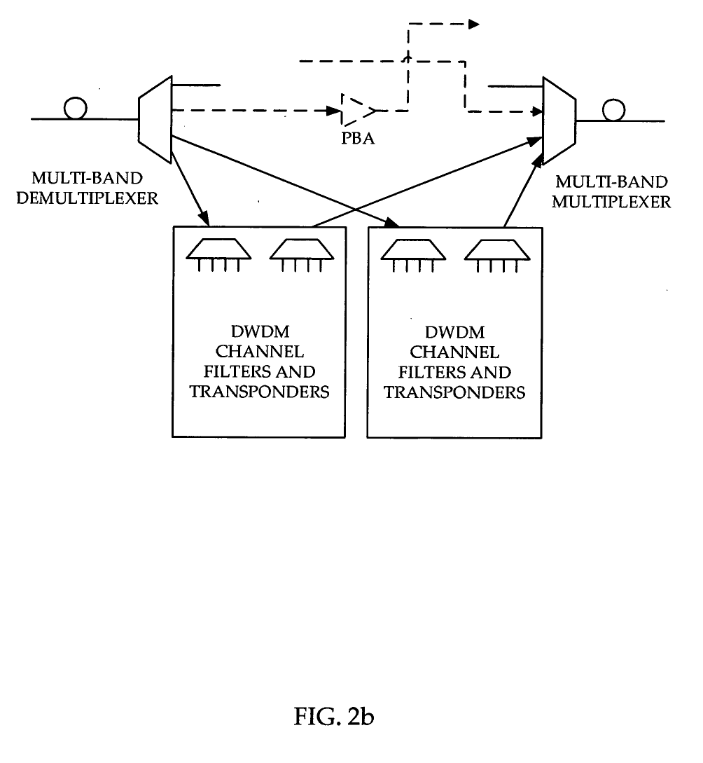

The multi-band architecture according to the present invention consists in deploying all the band filters at every site. FIG. 2a illustrates a hubbed ring with meshed traffic patterns deployed with this approach. Traffic from a given band is either dropped or passed through at each site. Changing the connectivity of a band at any given site only involves that band, without affecting the other bands. The flexibility of this approach is better suited for the complex and changing traffic patterns seen in today's network.

For rings with a smaller number of wavelengths, a variation to this approach consists in deploying half the bands in the initial phase. When the number of channels is about to exceed the number of wavelengths that can be practically used, the balance of the bands can be deployed by connecting them to the express port of the first half of the bands. For example, in a ring with a capacity of 32 wavelengths partitioned in 8 bands of 4 channels, the first four bands can be initially deployed to provide 16 channels. When the networks require more capacity four more bands can be deployed to provide up to 32 channels by connecting the extra four-band filter to the express port of the initial four-band filter.

The multi-band approach is even more attractive in networks where optical amplifiers are required. In such networks using the traditional single band filter approach, optical power equalization is required at amplifier sites located after an optical add/drop site. The equalization consists in lowering the power of all the channels on the fiber to the same level as the channel with the lowest optical power in order that all the channels, being amplified by the EDFA, have the same input power. This is very inefficient and would likely results in the deployment of more optical amplifiers than needed.

When the multi-band approach is used, all the bands are split at every site. The channels in bands that are not dropped at a given site can be amplified with very low cost EDFAs and exit the node with the same optical power as the channels in bands that are added at that site. This low cost amplification on a per band basis is called Per Band Amplifier (PBA). This eliminates the need for expensive optical power equalization and full C-band amplification at or close to the OADM site. When amplifiers are required for links longer than 60 to 80 km, expensive power equalization is not needed since all the channels leaving the OADM site are already at the same power level.

Another benefit of this approach is to enable the addition of optical channels around the ring without interrupting the traffic from other bands around the ring. When a channel needs to be dropped at a site, the patchcord or PBA is replaced with a Fixed OADM (FOADM) filter and optical transponders.

This approach works particularly well with a Configurable Optical Add Drop Multiplexer (COADM). When a channel from a band needs to be dropped at a site, a COADM can be added between the west and east-facing multi-band multiplexer to extract and add the given channel. The other channels of that bands that are optically passing through the site are amplified with a PBA to avoid the high cost of Optical-Electrical-Optical (OEO) regeneration. As more channels are needed at that site, the COADM can be configured to add and drop the extra channels.

Finally, a key benefit of the multi-band approach combined with PBA is that the optical link engineering is as simple as the point to point link engineering of SONET rings without the cost of OEO regeneration. Since all the channels coming out of OADM sites are at the same optical power as the channels that are added at those sites, it is, from an optical power point of view, like if every channels passing through the node had been regenerated. This simplifies the optical link engineering to a point to point system.

This architecture can also benefit optical Re-configurable Optical Add Drop Multiplexer (ROADM) applications. Since the cost per port is fairly high in a ROADM, configuring the ROADM to drop individual bands instead of individual wavelengths substantially reduces the cost per wavelength. All the passthrough channels exit on the express port of the ROADM whether other channels from the same band are dropped or not.

1. A filter architecture for use at an access site in an optical communication system capable of transporting a plurality of multiple wavelength bands in a transmission medium, at least one of the multiple wavelength bands having at least one wavelength to be forwarded through the access site, the architecture comprising:
for each of the plurality of multiple wavelength bands, a dropping filter for removing the band from the transmission medium; and
for each of the plurality of multiple wavelength bands, means for adding the band downstream to the transmission medium of the dropping filter,
whereby each band having at least one wavelength to be forwarded through the access site is dropped and then added.

2. The filter architecture of claim 1 further comprising:
for each band having at least one wavelength to be forwarded, an optical amplifier for amplifying the band to an optical power comparable to that of any band being added at the access site, the optical amplifier being between the dropping filter and the means for adding the band.

3. The filter architecture of claim 2 wherein at least one optical amplifier is an Erbium Doped Fiber Amplifier.

4. The filter architecture of claim 2 further comprising:
for each band which includes at least one wavelength to be forwarded and at least one wavelength to be dropped, a Configurable Optical Add-Drop Multiplexer for removing the at least one channel to be dropped; and
for each band which includes at least one wavelength to be forwarded and at least one wavelength to be dropped, an optical amplifier for amplifying the at least one wavelength to be forwarded to a wavelength optical power comparable to that of wavelengths being added.

5. The filter architecture of claim 1 wherein the filter is a Re-configurable Optical Add Drop Multiplexer (ROADM), and wherein each band enters the ROADM on a respective port.

6. A method of managing bands at an access site in an optical communication system capable of transporting a plurality of multiple wavelength bands over a transmission medium, comprising:
removing each band of the plurality of multiple wavelength bands from the transmission medium using a respective dropping filter; and
re-introducing each multiple wavelength band to the transmission medium,
whereby each multiple wavelength band having at least one wavelength to be forwarded through the access site is removed from the transmission medium and then re-introduced to the transmission medium.

7. The method of claim 6 further comprising:
for each band having at least one wavelength to be forwarded, amplifying the band to an optical power comparable to that of any band being added at the access site, prior to re-introducing the band to the transmission medium.
